(19) United States
(12) Patent Application Publication
(10) Pub. No.: US 2026/0136082 A1
(43) Pub. Date: May 14, 2026

(54) TARGETED VIDEO CLIP GENERATION

(71) Applicant: DISH Network Technologies India Private Limited, Bengaluru (IN)

(72) Inventors: Sagar C. Bellad, Bengaluru (IN); Shishir Pandey, Secunderabad (IN)

(21) Appl. No.: 19/034,784

(22) Filed: Jan. 23, 2025

(30) Foreign Application Priority Data
Nov. 8, 2024 (IN) 202441086164

(51) Int. Cl. H04N 21/8549; G06V 20/40; H04N 21/234; H04N 21/2668

(52) U.S. Cl. CPC H04N 21/8549; G06V 20/47; H04N 21/23418; H04N 21/2668

(57) ABSTRACT

Systems, devices, and methods related to targeted video clip generation are provided. In one example, a computer system includes one or more processors and a computer-readable storage media storing computer-executable instructions. The instructions when executed by the one or more processors cause the computer system to identify a genre based on a user profile, access a media content item including multiple video frames, identify a video frame from the multiple video frames based on the identified genre, and generate a targeted media clip including the identified video frame.

### CROSS REFERENCE TO RELATED APPLICATIONS

This application claims priority to Indian Provisional Patent Application No. 202441086164 filed on Nov. 8, 2024, in the Indian Intellectual Property Office, the disclosure of which is incorporated by reference in its entirety for all purposes.

### BACKGROUND OF THE DISCLOSURE

Video clips, often referred to as previews, trailers, or teasers, are short segments of video content designed to capture viewer attention and provide a glimpse of the main content without revealing significant plot points. Streaming service providers utilize these clips to inform viewers about the content, engage their interest, and drive viewership. Additionally, these clips serve as useful visual references for users navigating through the streaming platform's offerings.

### BRIEF SUMMARY OF THE DISCLOSURE

According to some embodiments of the present disclosure, a method for generating targeted media clips is provided. The method may be performed by a media clip generation system. The method includes identifying a genre based on a user profile, accessing a media content item that includes multiple video frames, identifying a video frame from the multiple video frames based on the identified genre, and generating a targeted media clip including the identified video frame.

According to some embodiments of the present disclosure, a computer system or computer device is provided. The computer system or computer device includes one or more processors and a computer-readable storage media storing computer-executable instructions. The instructions when executed by the one or more processors cause the computer system or computer device to identify a genre based on a user profile, access a media content item including a plurality of video frames, identify a video frame from the plurality of video frames based on the identified genre, and generate a targeted media clip including the identified video frame.

In accordance with some embodiments, the present disclosure also provides a non-transitory machine-readable storage medium encoded with instructions, the instructions executable to cause one or more electronic processors of a computer system or computer device to perform any one of the methods or processes described in the present disclosure.

### BRIEF DESCRIPTION OF THE DRAWINGS

FIG. 1 is a block diagram illustrating an example media streaming system, according to various embodiments of the present disclosure.

FIG. 2 is an example table of metadata of a media content item, according to various embodiments of the present disclosure.

FIG. 3 illustrates an example of a character interaction graph of multiple characters shown on a video frame of a media content item, according to various embodiments of the present disclosure.

FIG. 4 illustrates an example video frame of a media content item showing unverified character and a pair of characters with similar features, according to various embodiments of the present disclosure.

FIG. 5 is a flow diagram illustrating an example method for media clip generation, according to various embodiments of the present disclosure.

FIG. 6 is a flow diagram another example method for media clip generation, according to various embodiments of the present disclosure.

FIG. 7 is a flow diagram illustrating an example method for determining an image relevance of a media content item, according to various embodiments of the present disclosure.

FIG. 8 is a flow diagram illustrating an example method for determining an audio relevance of a media content item, according to various embodiments of the present disclosure.

FIG. 9 is a flow diagram illustrating an example method for determining a text relevance of a media content item, according to various embodiments of the present disclosure.

FIG. 10 is a flow diagram illustrating an example method for determining a video frame relevance of a media content item, according to various embodiments of the present disclosure.

FIG. 11 is a flow diagram illustrating another example method for media clip generation, according to various embodiments of the present disclosure.

### DETAILED DESCRIPTION OF THE DISCLOSURE

The present disclosure provides techniques related to generating and providing user-specific media clips tailored to an individual's or user account's genre preferences. When a user views a clip of video content on a streaming service platform or via some other on-demand arrangement (e.g., stored by a television receiver or television), the user can decide whether to watch the full content based on the genre represented in the clip. Users may be more likely to select the corresponding video content for viewing if the clip aligns with their preferred genre. For example, a user who prefers the comedy genre may be more inclined to watch content if the clip reflects the comedy genre, whereas they might be less interested if the clip represents the drama genre. Traditionally, media content clips are provided to streaming service providers in a universal format by content providers. Therefore, conventionally, the same clip is shown to all users. This “one-size-fits-all” approach fails to adequately represent all genres and lacks the diversity needed to cater to individual user preferences.

One insight provided in the present disclosure is related to generation of targeted media clips. Targeted media clips can refer to user-specific or account-specific media clips. (Throughout this document, user-specific should also be understood to refer generally to personalized media clips or targeted media clips, which include account-specific media clips. Such account-specific media clips can refer to media clips which are targeted at an account used by one or more users.) In accordance with some embodiments, a media clip generation system is configured to identify a user-specific genre based on a user profile, access a media content item including a sequence of video frames, identify a video frame from the multiple video frames that are closely relevant to the user-specific genre, and generate a targeted, personalized, and user-specific media clip that includes the identified video frame. Tailoring clips to individual genre preferences significantly increases the likelihood of user engagement. Personalized clips can resonate more deeply with users, assist users in discovering content that aligns with their tastes, and capture their attention and interest more effectively than generic clips. When users view previews that reflect their preferred genres, they are more likely to decide to watch the full content. This results in higher conversion rates from preview views to full content views and boost overall viewership and retention rates for the streaming service. Consistently providing clips that match user preferences enhances user satisfaction and loyalty.

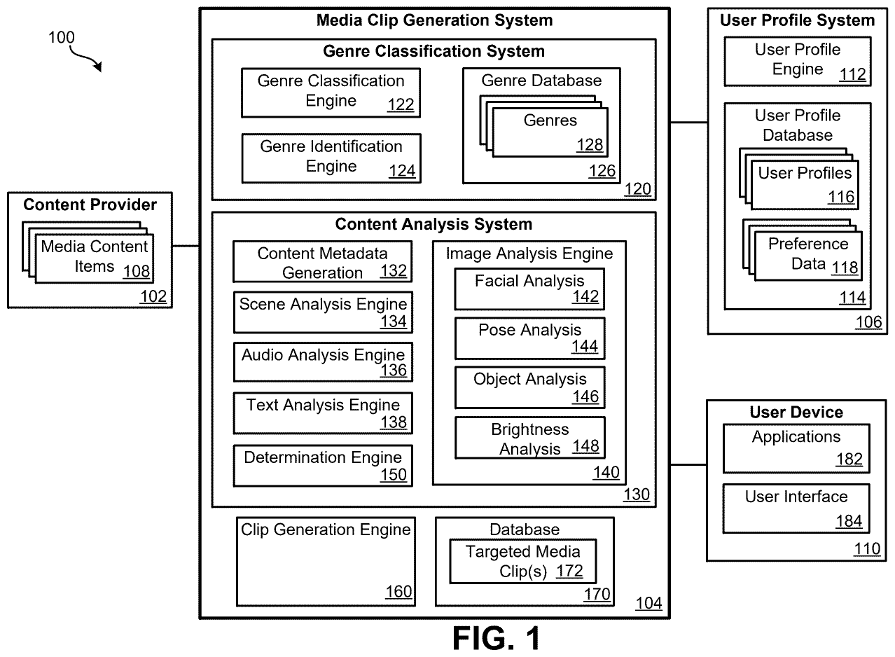

Further details regarding these embodiments and additional embodiments are provided in relation to the figures. FIG. 1 illustrates a block diagram of an embodiment of a media streaming system 100 (“system 100”). System 100 can include content provider 102, media clip generation system 104 (hereinafter “system 104”), user profile system 106, and user device 110. The user profile system 106 can include a user profile engine 112 and a user profile database 114. The media clip generation system 104 can further include a genre classification system 120, a content analysis system 130, a media clip generation engine 160, and a database 170. The genre classification system 120 may further include a genre classification engine 122, a genre identification engine 124, and a genre database 126.

Each component of system 100 may be a computer system or a computer device. For example, an “engine” used herein may refer to a hardware component such as a computer device, a server, or a part of a cloud-based computing platform. An engine may further include a software component executable on the hardware of the engine, such as a module, a service, an application, or a cloud-based service. The components of system 100 may be in communication with each other via a communication network such as Internet. Fewer or additional components can be included in system 100. For example, system 100 may include an over-the-air (OTA) content delivery system, an over-the-top (OTT) content delivery system, an IPTV (Internet Protocol Television) content distribution system, a content delivery network (CDN), local networks, and various network devices to facilitate transmission and distribution of media content, messages, or data among various components in system 100.

The content provider 102 may include one or more content servers operable and configured to provide a source of media content items and provide access to the media content items to the media clip generation system 104 and the user device 110. A media content item refers to any form of digital media that delivers information or entertainment to a user, including video, audio, text, or interactive content. Examples of media content items include but are not limited to movies, TV shows, series, podcasts, music tracks, video games, and live-streaming events.

In some embodiments, the media content item 108 includes multiple video frames in sequence and corresponding audio data and text data associated with each video frame. The video frames may be timestamped or designated with a unique frame ID for each video frame. Video frames may be in various resolutions, such as 720p (HD), 1080p (Full HD), 1440p (Quad HD), and 2160p (4K Ultra HD). The media content item may be streamed at various frame rates, measured in frames per second (fps), such as 24 fps (standard for film), 30 fps (standard for TV), and 60 fps (standard for high-definition video and gaming). Depending on the duration and frame rate, a media content item may have various numbers of frames. Each video frame includes image data, audio data, and text data, among others. The audio data can include vocal data, sound data, and background music data, among others. Audio data can be synchronized with each video frame according to the timestamps. Corresponding text data, such as subtitles or closed captions, can be associated with each frame to provide additional context or accessibility options for viewers.

At a high level, the media clip generation system 104 is operable and configured to generate targeted media clips containing representative content, targeted at a user or a user account, from a media content item. Within the media clip generation system 104, the genre classification system 120 is configured to identify a user-specific (or account-specific) genre; the content analysis system 130 is operable and configured to analyze a media content item 108, generate video frame metadata for the media content item 108, and determine the representative content of the media content item relevant to the identified user-specific genre; the clip generation engine 160 is configured to generate a targeted media clip containing the representative content. More details of the media clip generation system 104 and the components thereof as well as implementation examples are described below.

The user profile system 106 can include a user profile engine 112 and a user profile database 114. The user profile engine 112 is operable and configured to determine a user interest on media content. The user profile database 114 is operable and configured to store user profiles 116 and user preference data 118 and provide access to the user profiles 116 and the user preference data 118 to the media clip generation system 104. In some embodiments, the user profile system 106 is an integral part of the media clip generation system 104.

In some embodiments, the user interest is a genre or theme of media content specific to or preferred by the user or associated with a user account. For example, the media content may be movies or TV shows, and examples of the genre may include comedy, romantic, horror, action, drama, science fiction, documentary, etc. In some embodiments, the user interest may be a user-preferred emotion or mood that a media content item can evoke. Examples of emotion include but are not limited to happiness, excitement, amusement, fear, sadness, nostalgia, romance, inspiration, serenity, surprise, empathy, curiosity, adventure, suspense, triumph, wonder, smile, calm, suppression, anger, disgust, confusion, etc.

The user profile engine 112 can determine the user interest based on the user information provided in a user profile 116 stored in the user profile database. For example, the user interest can be indicated by the user (e.g., from a user input or user selection). In some embodiments, the user profile engine 112 can access historical user viewership data and determine a user interest or user preference based on the historical user viewership data. For example, the user profile engine 112 can analyze the types of media content the user has previously watched, the frequency of views, playback of scenes, and engagement levels with different genres of the content or the emotions and moods evoked by the content. Based on the viewership information, the user profile engine 112 can identify user preferences on a particular genre, emotion, or mood. In some embodiments, multiple user accounts are associated with the user profile, and the user preference on genre or emotion for each user account can be determined respectively based on the user information and user viewership data provided in each user account. The user preference data 118 indicative of user-preferred genre, theme, emotion, or mood may also be stored in the user profile database 126.

The user device 110 may be a media streaming device that includes one or more executable applications 182 and a user interface 184. The applications 182 when executed can cause the user device 110 to receive and stream the targeted media clips generated by the media clip generation system to allow the user to view and interact with the targeted media clips via the user interface 184. Examples of the user device 110 include but are not limited to smartphones, tablets, personal computers (PCs), smart TVs, set-top-boxes (STBs), gaming consoles, virtual reality (VR) headsets, digital media adapters, entertainment systems, smart projectors, etc.

In the illustrated example of FIG. 1, the genre classification system 120 of the media clip generation system 104 may further include a genre classification engine 122, a genre identification engine 124, and a genre database 126. The genre classification engine 122 is operable and configured to establish and define a class of genres 128 and classify the media content items 108 provided by the content provider 102 based on predefined genres 128. For example, the genre classification engine 122 can assign one or more predefined genres 128, such as comedy, classical, romance, horror, etc., to each one of a group of movies based on the contextual information of the movies provided by the content provider 102.

The genre identification engine 124 is operable and configured to identify a genre specific to a user or user account, based on the user profile 116 and/or the user preference data 118 provided by the user profile system 106. For example, if the user profile indicates that a user prefers “comedy” movies, the genre identification engine 124 identifies the genre “comedy” as the user-specific or user-preferred genre for the user. In some embodiments, the genre identification engine 124 can identify a user-specific genre based on the user preference data 118 indicative of one or more user-preferred emotions or moods that are closely relevant to a genre 128. For example, if the user preference data 118 indicates that the user prefers “romantic” emotion, the genre identification engine 124 identifies the “romantic” and “romantic comedy” genres as the user-specific genre. The user-specific or user-preferred genres identified by the genre classification engine 122 are utilized to generate targeted media clips of a media content item that aligns with these user-specific or user-preferred genres.

The content analysis system 130 can further include a content metadata generation engine 132, a scene analysis engine 134, an audio analysis engine 136, a text analysis engine 138, an image analysis engine 140, and a video frame relevance determination engine 150.

The content metadata generation engine 132 is operable and configured to analyze the image data, audio data, and text data of video frames of the media content item 108, and generate various analytical metadata for each video frame. In some embodiments, the content metadata generation engine 132 may implement various recognition tools and recognition models to analyze the content of the media content item. Examples of the recognition tools and models can include scene recognition, face recognition, object recognition, pose recognition, voice recognition, sound recognition, music recognition, and text recognition. The content metadata generation engine 132 can identify various visual features, vocal features, sound effects, musical features, and textual features. Examples of the features include but are not limited to faces and bodies of characters, objects, poses/gestures, voices, dialogues, background music, text, interaction between characters, interaction between character and object, etc., The content metadata generation engine 132 can also extract other contextual information associated with each video frame.

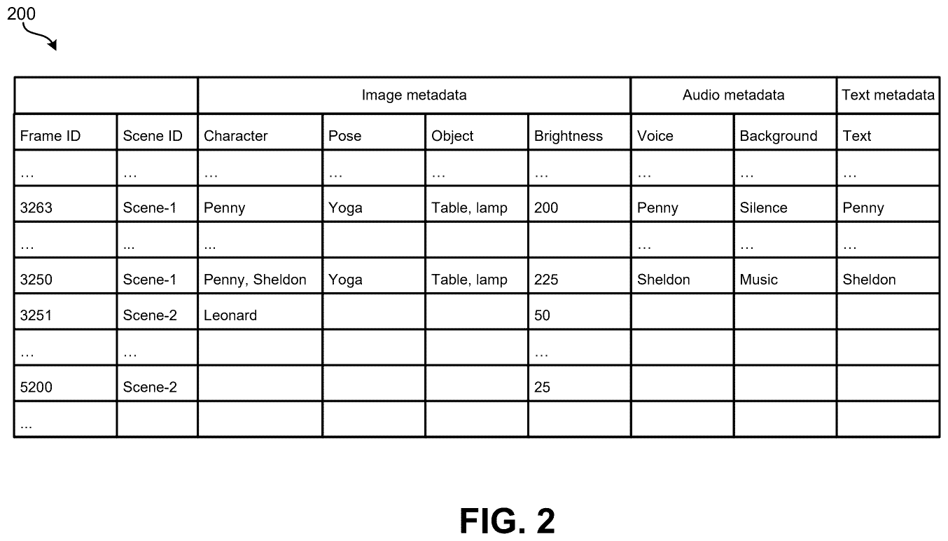

FIG. 2 illustrates an example data table 200 showing various metadata associated with a media content item 108, generated by the content metadata generation engine 132. In the illustrated example, data table 200 includes a sequence of rows respectively representing the sequence of video frames of a media content item. Each video frame carries a unique frame ID and a unique scene ID. The consecutive video frames associated with the same scene may carry the same scene ID (e.g., the video frames with frame ID from 3263-3250) are assigned the same scene ID (e.g., Scene-1). Each row of the data table 400 further includes image metadata, audio metadata, and text metadata for the corresponding video frame. The image metadata can include various visual features recognized, detected, and identified in the video frame, such as character(s), object(s), pose(s) of the characters, interaction between the characters, interaction between a character with an object, brightness, etc. In some embodiments, the brightness is represented quantitatively, such as by a brightness pixel value on a predetermined scale. The audio metadata can include various audio features recognized, detected, and identified in the audio data corresponding to the video frame, such as volume, pitch, frequency spectrum, etc. In some embodiments, the audio metadata can also include specific sound events (e.g., dialogues, background music, sound effects) for a scene segment (e.g., a subset of consecutive video frames within the same scene). The text metadata may include textual features recognized, detected, and identified in the audio data corresponding to the video frame, such as subtitles, on-screen text, and closed captions. In some embodiments, the text metadata can also include dialogue, context, or narrative for a scene segment.

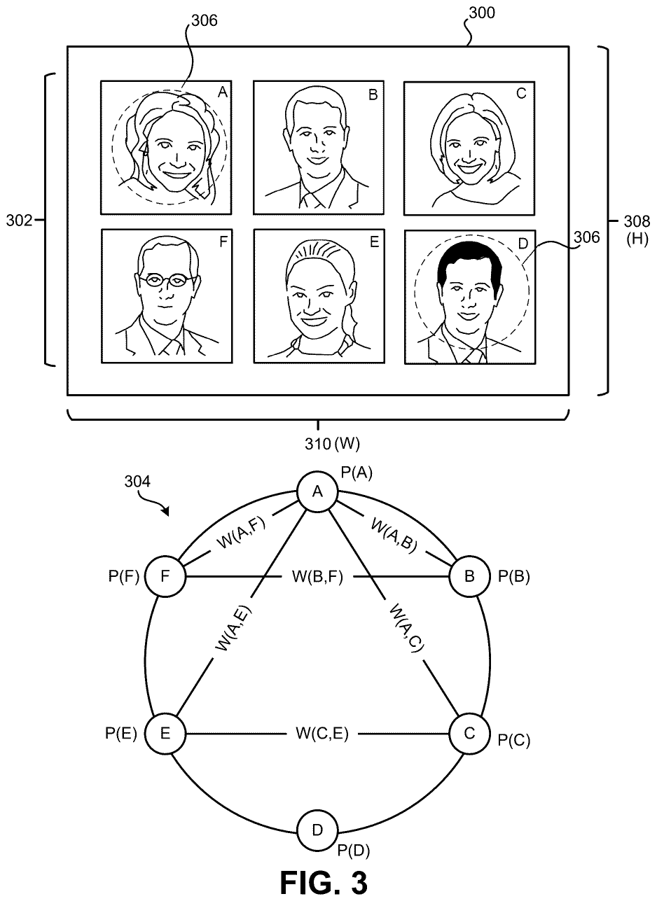

Referring back to FIG. 1, the scene analysis engine 134 is operable and configured to identify one or more scenes based on the video frame metadata, assign a scene ID (e.g., the scene ID shown in FIG. 3) to each video frame, and detect scene changes along the sequence of video frames. Various scene-change detection algorithms or models can be utilized. For example, the histograms of consecutive video frames can be compared, and a difference in the histogram values larger than a threshold indicates a scene change. The difference between the pixel values of consecutive video frames can be computed, and a difference larger than a threshold level indicates a scene change. Other features and information of the video frames such as edge pattern, color distribution, motion vector, etc., can also be used to detect scene change. In some embodiments, audio metadata that indicates variations in audio features can be used to identify changes that correlate with scene transitions. In some embodiments, text metadata can be utilized to identify shifts in dialogue, context, or narrative that correlate with scene transitions. In some embodiments, a combination of two or more of the image metadata, audio metadata, and text metadata may be utilized to detect the scene change.

The image analysis engine 140 is operable and configured to analyze the image metadata and image features, determine an image relevance to the user-specific or user-preferred genre, based on the image metadata, and identify a video frame relevant to the user-specific or user-preferred genre based on the image relevance. In some embodiments, the image analysis engine 140 further includes a facial analysis module 142, a pose analysis module 144, an object analysis module 146, and a brightness analysis module 148. The facial analysis module 142 is configured to determine a facial expression relevance (or facial relevance) to the user-specific or user-preferred genre, the pose analysis module 144 is configured to determine a pose expression relevance (or pose relevance) to the user-specific or user-preferred genre, the object analysis module 146 is configured to determine an object relevance to the user-specific or user-preferred genre, and the brightness analysis module 148 is configured to determine a brightness relevance to the user-specific or user-preferred genre.

In some embodiments, the facial analysis module 142 can identify a facial expression based on the image metadata, calculate a prominence score, calculate a facial expression score, and determine a facial relevance based on the prominence score and the facial expression score. The facial relevance can be a factor in determining the video frame relevance.

For example, the facial analysis module 142 can execute a function utilizing Equation (1) to determine the prominence score (psᵢ) for the video frame with a frame ID of i:

$$p {s}_{i} = ( \frac{{\sum }_{j = 0} {p}_{j} \times {A}_{j}}{W \times H} ) + ( \frac{{\sum }_{j , k = 0}^{j \neq k} {w}_{j , k} \times ( {A}_{j} + {A}_{k} )}{W * H} ) ; \qquad Equation ( 1 )$$

In Equation (1), pⱼ is the prominence index of character j, which is defined by the number of times character j has appeared in all of the video frames through the entirety of the media content item 108. Aⱼ is an area (A) of a face of character j within a video frame; Aₖ is an area of character k's face within the a video frame; w_{j,k} is the number of times characters j and k appear together in the video frames; W is a width of the video frame; and H is a height of the video frame.

The prominence of character j can be described by Equation (1a):

$${p}_{j} = \frac{number of video frame appearances of character j}{total unber of times any character has appeared} ; \qquad Equation ( 1 a )$$

The prominence of characters j and k together can be described by Equation (1b):

$${w}_{j , k} = \frac{\begin{matrix}number of video frame appearances \\ of characters j and k\end{matrix}}{\begin{matrix}total unber of interactions of any two \\ or more characters\end{matrix}} ; \qquad Equation ( 1 b )$$

According to Equation (1), the prominence score (psᵢ) is proportional to the width and the height of video frames. Additionally, the prominence score is proportional to a number of times the character has interacted with a selected one of the main characters, and proportional to an area occupied by a face of the selected one of the main characters.

According to Equation (1), the prominence score (psᵢ) also takes into account the interaction between characters. FIG. 3 illustrates an example of a character interaction graph of multiple characters shown on a video frame of a media content item 108. In the illustrated example, a video frame 300 is shown, among the multiple video frames of the media content item 108. The video frame 300 shows multiple characters 302. A character interaction graph 304 illustrates an interaction of each one of the multiple characters 302 in each one of the multiple video frames. In one example, the multiple characters 302 can be represented by alphanumerically as characters A-F, although it is understood that a fewer or greater number of characters can be represented among the multiple characters 302. To facilitate discussion, and for purposes of illustrating examples, the characters A-F can be named as follows: A (“Alba”), B (“Brian”), C (“Clara”), D (“David”), E (“Elena”), and F (“Farid”). The names and alphanumeric values are used interchangeably throughout the present disclosure.

The facial analysis module 142 can generate a character interaction graph 304 to represent the interactions among characters A-F within the video frames. The character interaction graph 304 calculates self-loops, i.e., a video frame where a single one of the characters A-F appears alone. The character having the highest self-loop can be designated as a most prominent character. Image or facial recognition tools/models can be utilized to distinguish between characters A-F. In some embodiments, the foreground and background characters within a given video frame can be detected. A predetermined prominence index (Pᵢ) for each character is obtained for characters A-F. An area A of each characters A-F face 306 is obtained for each video frame. For example, Alba might have a prominence index P(A)=100, because she appeared one hundred times in the subset of video frames that show at least one character or the entirety of the media content item. While illustrated in FIG. 3 as a circle for simplicity, it is understood that the area (A) of a character's face 306 can be obtained by image processing tools/models, such that the area (A) may be represented by other shapes, including non-uniform shapes. Each character interaction (i.e., appearance in a same video frame) between any one character and the remaining characters is determined within the video frames. Accordingly, an interaction index (w_{j,k}) indicates the number of times character j interacts with another character, k, where characters j and k are a subset of characters A-F. For example, Alba has an interaction index w for each time Alba appears with another character B-F. The interaction index w_{j,k} increments by 1 for each video frame in which j and k appear together.

As illustrated in Equation (1), the prominence index (pⱼ), the interaction index (w_{j,k}), the area (Aⱼ) of individual character j's face, the area (Aₖ) of individual character k's face, and the height 310 and width 312 of the video frame 500 are used as input for calculating the prominence score (psᵢ). In some embodiments, the prominence score (psᵢ) is determined for each one of the multiple characters 302. In other embodiments, the prominence score (psᵢ) is determined for a subset of the multiple characters 302, such as one or more “main characters.” The one or more “main characters” can be predetermined (e.g., from the contextual information or content description provided by the content provider 102), or indicated by the user profile 116 or the user preference data 118.

Referring back to FIG. 1, the facial analysis module 142 can further execute another function utilizing Equation (2) to determine the facial expression score (exᵢ) for the video frame “i.”

$$e {x}_{i} = ( \frac{{\sum }_{j = 0} {c}_{j} \times e {x}_{j} \times {A}_{j}}{T ( g ) \times ( W \times H )} ) ; \qquad Equation ( 2 )$$

In Equation (2), cⱼ is a confidence score that indicates a degree of confidence that expression is an actual expression of character j; exⱼ is a standard expression index (or emotion/mood index) of a predefined expression for a predefined genre 128. In some embodiments, the exⱼ can be retrieved from a preestablished dataset that specifies the standard expression indices for each one of multiple predefined expressions (e.g., emotions or moods) for each genre. An example dataset is provided in Table 1.

TABLE 1
Pre-established dataset showing standard expression indices for a predefined genre.

| Genre 1 (“Comedy”) | | Genre 2 (“Romantic”) | | Genre 3 (“Horror”) | |
|---|---|---|---|---|---|
| | Facial | | Facial | | Facial |
| Expression | Expression | Expression | Expression | Expression | Expression |
| (Emotion or | Index | (Emotion or | Index | (Emotion or | Index |
| Mood) | (VALUE) | Mood) | (VALUE) | Mood) | (VALUE) |
| HAPPY | 10 | HAPPY | 10 | FEAR | 10 |
| SMILE | 9 | SMILE | 10 | SAD | 10 |
| CALM | 8 | CALM | 10 | CONFUSED | 9 |
| SUPPRESSED | 4 | SUPPRESSED | 4 | DISGUSTED | 9 |
| FEAR | 0 | FEAR | 0 | ANGRY | 9 |
| ANGRY | 0 | ANGRY | 0 | SURPRISED | 0 |
| DISGUSTED | 0 | DISGUSTED | 0 | CALM | 0 |
| CONFUSED | 0 | CONFUSED | 0 | SMILE | 0 |
| SAD | 0 | SAD | 0 | HAPPY | 0 |
| TOTAL [G1] | 31 | TOTAL [G2] | 34 | TOTAL [G3] | 47 |

For example, if a facial expression identified from the image metadata indicates a “HAPPY” emotion or mood of character j in the video frame “i,” the exⱼ of the video frame “i” is 10 for the “Comedy” and “Romantic” genres, and the exⱼ of the video frame “i” is 0 for the “Horror” genre, according to Table 1. If the user-specific or user-preferred genre is “Comedy” or “Romantic,” the exⱼ is higher, and the facial expression score (exᵢ) calculated from exⱼ is also relatively high (e.g., with a value of “10”), indicating that the video frame “i” is more relevant to the user-specific or user-preferred genre. On the other hand, if the user-specific or user-preferred genre is “Horror,” the exⱼ is low (e.g., with a value of “0” according to Table 1), and the facial expression score (exᵢ) calculated from exⱼ is low, indicating that the video frame “i” is remote from the user-specific or user-preferred genre.

The confidence score (cⱼ) is expressed as a probability (e.g., percentage) that the determined expression for the face of character j is an actual expression on the face of character j. As indicated in Equation (2), the facial expression score (exᵢ) includes a confidence level (i.e., confidence score) that corresponds to a probability of closely the determined expression of the character matches an actual expression of the character in the video frame “i.”

A total expression score for a given genre, T (g) is represented by a sum of all of the expressions for a predefined genre 128. For example, the TOTAL [G1], TOTAL [G2], and TOTAL [G3], as shown in Table 1, represent the total expression score for the “Comedy” genre, the “Romantic” genre, and the “Horror” genre, respectively.

As illustrated in Equation (2), the facial expression score (exⱼ) also takes into account the relative size of the face of character j (Aⱼ) to the total area (W×H) of the video frame (image). The facial expression score (exⱼ) may be calculated by an aggregation of the facial expression index for each character j shown in the video frame “i.”

In some embodiments, the facial analysis module 142 can also determine a gender diversity score (gdᵢ) for the video frame “i.” For example, the “Romantic” genre may have two sub-genres, “Heterosexual” sub-genre and “Homosexual” sub-genre. In a video frame where a couples of opposite-gender appear, the expression score (exᵢ) is magnified by a factor (e.g., with a value of 4) for the “Heterosexual” sub-genre of the “Romantic” genre. In a video frame where a couple of same-gender appear, the expression score (ex;) is magnified by a factor (e.g., with a value of 4) for the “Homosexual” sub-genre of the “Romantic” genre. For the “Romantic” genre, a predetermined main character receives a higher prominence score compared with other characters.

In some embodiments, the facial analysis module 142 is configured to further determine a drama expression score (dexᵢ) for a media content item classified as the “Dramatic” genre. The facial analysis module 142 can identify video frames containing the highest number of predetermined main characters and execute a function utilizing Equation (3) to calculate the drama expression score (dexᵢ).

$${dex}_{i} = {ex}_{i} \pm \frac{number of characters identified within a frame}{\frac{total number of character}{appearing in the media content item}} ; \qquad Equation ( 3 )$$

In some embodiments, the facial analysis module 142 is configured to further determine an aesthetic score (asᵢ), based on an aesthetic quality of the image of the video frame such as colors, contrast, sharpness, resolution, noise, and artifacts.

The facial analysis module 142 can determine a facial expression relevance the user-specific or user-preferred genre by a combination of the prominence score (psᵢ) and facial expression score (exⱼ) or variations of the facial expression score (exⱼ) (e.g., dexᵢ, asᵢ, etc.) for the video frame “i.” For example, a weight may be assigned to each one of the prominence score (psi) and facial expression score (exⱼ), and a sum of the weighted prominence score (psi) and facial expression score (exⱼ) may be added together to yield the facial expression relevance. The facial analysis module 142 may rank the video frames according to the facial expression relevance, and the video frame having the highest ranking with respect to a predefined genre is selected as the video frame most relevant to the predefined genre. If the predefined genre is determined to be the user-specific or user-preferred genre identified according to the user profile or user preference, the video frame having the highest ranking for the predefined genre is selected as the video frame for the generation of the targeted and user-specific media clip for the media content item.

The pose analysis module 144 is configured to analyze the pose metadata for each video frame, identify a pose expression of a character shown in the video frame, and determine a pose relevance based on the pose expression for each video frame. In some embodiments, the pose analysis module 144 can execute a function utilizing Equation (4) to determine a pose expression score (posᵢ) for a predefined genre.

$${pos}_{i} = \frac{{\sum }_{j = 0} {po}_{j} \times \{ \frac{\begin{matrix}i \to if pose expression is \\ relevant to a predefined genre\end{matrix}}{0 \to else} \} \times {A}_{j}}{( W \times H )} ; \qquad Equation ( 4 )$$

In Equation (4), poⱼ represents a standard pose index of an identified pose expression of character j for a predefined genre. For example, a pre-established dataset of a class of pose expressions related to a predefined genre (e.g., the “Comedy” genre) can be accessed. The dataset contains a standard pose expression index (poⱼ) for each pose expression. For example, if a pose expression “Yoga” of character j is identified in video frame “i,”, “Yoga” is found as one of the standard pose expressions for the “Comedy” genre, and a standard expression index (poⱼ) for “Yoga” is predetermined as “10” in the dataset, then the poⱼ of the video frame is assigned a value of 10 in determining the posᵢ for the “Comedy” genre. Similarly, if a dataset for the “Romantic” genre specifies that “Yoga” is one of the class of standard pose expressions related to the “Romantic” genre, and a predetermined pose expression index (poⱼ) for “Yoga” is “5” for the “Romantic” genre, then the poⱼ of the video frame “i” is assigned a value of 5 for determining the posᵢ for the “Romantic” genre. On the other hand, if the identified pose expression (e.g., “Yoga”) is determined to be irrelevant to the predefined genre (e.g., the “Horror” genre), the standard pose expression index (poⱼ) is zero and not considered in the calculation of the posⱼ for the predefined genre. Similar to the facial expression score (exᵢ), the pose expression score (posⱼ) also takes into account the relative size of the face or body of character j (Aⱼ) to the total area (W×H) of the video frame (image). The pose expression score (posⱼ) may be calculated by an aggregation of the facial expression indices for each character j shown in the video frame “i.”

The pose analysis module 144 can determine a pose relevance to the user-specific or user-preferred genre based on the pose expression score (posᵢ). In some embodiments, the pose analysis module 144 may rank the video frames according to the pose expression score (posᵢ), and the video frame having the highest ranking with respect to a predefined genre is selected as the video frame most relevant to the predefined genre. If the predefined genre is determined to be the user-specific or user-preferred genre identified according to the user profile or user preference, the video frame having the highest ranking for the predefined genre is selected as the video frame for the generation of the targeted media clip for the media content item.

The object analysis module 146 is operable and configured to analyze the object metadata for each video frame, identify an object of the video frame, and determine an object relevance based on the object for each video frame. In some embodiments, the object analysis module 146 can execute a function utilizing Equation (5) to determine an object score (obsᵢ) for a predefined genre.

$${obs}_{i} = {\sum }_{class = i}^{class = n} od {\%}_{class} \times \{ \frac{\begin{matrix}1 \to if object is relevant to a \\ predefined genre\end{matrix}}{0 \to else} \} ; \qquad Equation ( 5 )$$

In Equation (5), od %_{class} represents an object index of an identified object relevant to a total of reference objects for a predefined genre. As an example, the predefined “Action” genre has a class of reference objects (e.g., gun, car, fire, etc.), and a standard object index is 10 for the “Action” genre. If a gun is identified in the video frame “i,” and the gun is a reference object relevant to the “Action” genre, the object score (obsᵢ₎ is calculated to be 10. If both a gun and a car are identified, the gun and car are both reference objects relevant to the “Action” genre, and the standard object indices for the gun and car are 10 and 5 respectively, then the obsᵢ is calculated to be 10×50%+5×50%=12.5. On the other hand, the gun is not a reference object for the “Romantic” genre, and if a gun is identified in the video frame “i,” the gun bears no weight in calculating the obsᵢ for the “Romantic” genre, according to Equation (5).

The object analysis module 146 can determine an object relevance to the user-specific or user-preferred genre based on the object score (obsⱼ). In some embodiments, the object analysis module 146 may rank the video frames according to the object relevance, and the video frame having the highest ranking with respect to a predefined genre is selected as the video frame most relevant to the predefined genre. If the predefined genre is determined to be the user-specific or user-preferred genre identified according to the user profile or user preference, the video frame having the highest ranking for the predefined genre is selected as the video frame for the generation of the targeted media clip for the media content item.

The brightness analysis module 148 is configured to analyze the brightness of each video frame and determine a brightness relevance based on the brightness. The brightness relevant is a function of the predefined genre. In some embodiments, the brightness analysis module 148 can execute a function utilizing Equations (6a) and/or (6b) to determine a brightness score (bsᵢ) for video frame “i.”

$$b {s}_{i} ( Comedy ) = \{ \begin{matrix}\frac{pixel value}{255} , & if {bs}_{i} < 0.7 \\ 0 , & else\end{matrix} ; \qquad Equation ( 6 a )$$

$${bs}_{i} ( Horror ) = \{ \begin{matrix}1 - \frac{pixel value}{255} , & if ( 1 - b {s}_{i} ) > 0.25 \\ 0 , & else\end{matrix} ; \qquad Equation ( 6 b )$$

In Equation (6a), bsᵢ (Comedy) is a brightness score for the “Comedy” genre, if the value of bsᵢ is calculated to be less than 0.7. In Equation (6b), bsᵢ (Horror) is a brightness for the “Horror” genre, if the value of (1−bsᵢ) is calculated to be less than more than 0.25.

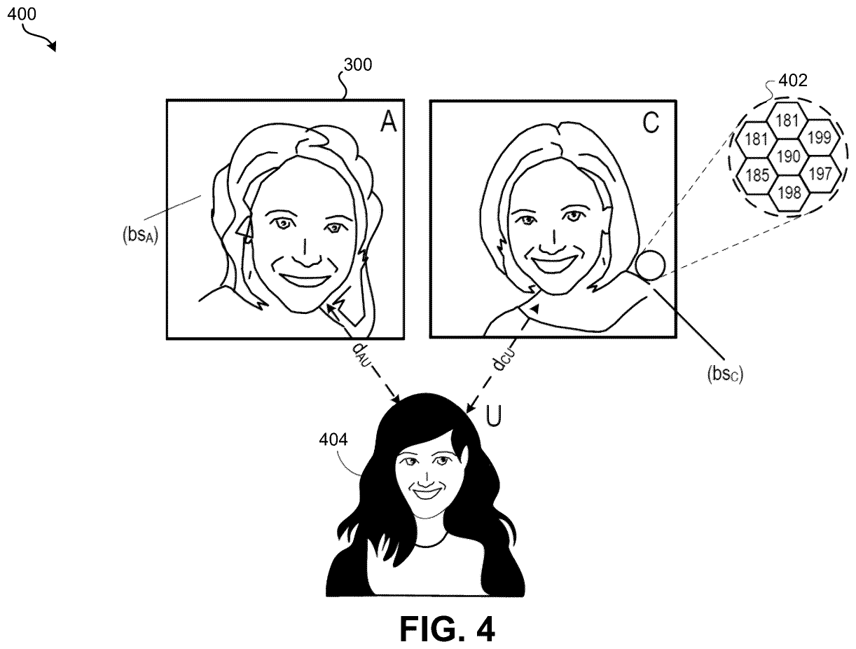

As illustrated in FIG. 4, in some embodiments, a value of each of the pixels 402 of the video frame 400 is determined and an average grayscale value of the pixels 602 is used to determine the brightness score (bsᵢ). With reference to Equations (5a) and (5b), the user profile 116 or the user preference data 118 may determine how the brightness score (bsᵢ) is determined based on classification of the predefined genres. For example, each one of the expression score (exᵢ) or brightness score (bsᵢ) is determined for a subset of the characters 402, such as one or more “main characters.” Data utilized to indicate the one or more “main characters” can be determined by analyzing information contained in the character metadata. In some embodiments, the brightness score (bsᵢ) can be utilized to distinguish between genres. For example, video frames identified as a “Romantic” or “Comedy” genre can have higher brightness scores (bsᵢ) than frames identified as “Dramatic” or “Horror.” When the user-specific or user-preferred genre is identified as “Comedy,” video frames having a brightness score (bsᵢ) below a predetermined brightness threshold (e.g., dark frames) are not classified as “Comedy.” When the user-specific or user-preferred genre is identified as “Horror,” video frames having a brightness score (bsᵢ) above a predetermined brightness threshold are not classified as “Horror.”

The audio analysis engine 136 is operable and configured to analyze the audio metadata of the media content item, extract audio features, determine an audio relevance to the user-specific or user-preferred genre based on the audio metadata, and identify a video frame relevant to the user-specific or user-preferred genre based on the audio relevance. In some embodiments, the audio analysis engine 136 can identify segments of the media content item based on audio events such as a character's continuous voice, uninterrupted dialogue, ongoing speech, a song, or a continuous piece of background music. These segments encompass a subset of consecutive video frames, with the audio event spanning the entirety of this subset.

The audio analysis engine 136 can extract vocal features of the audio event present in a vocal segment and determine a vocal expression (e.g., emotion or mood) for the vocal segment based on the vocal features. Examples of the vocal feature include identity of the voice (e.g., a main character), volume (loudness), tone, speech rate, voice timbre, formant frequencies, prosody (rhythm, stress, and intonation patterns), jitter (frequency variation), shimmer (amplitude variation), harmonics-to-noise ratio (HNR), speech energy, speech pauses, phonation type, and spectral features (such as spectral centroid, spectral flux, and spectral roll-off). The audio analysis engine 136 can determine a vocal expression score (vsᵢ) for each video frame of the vocal segment, based on the vocal features. The vsᵢ is an indicator of the emotion or mood of the vocal segment, and each video frame of the segment can have the same vsᵢ. The vsᵢ can be calculated based on a predefined formula specific to a predefined genre. For example, the calculated vsᵢ for the “Comedy” genre and the calculated vsᵢ for the “Horror” genre may be different for the same vocal segment. The audio analysis engine 136 can determine a vocal expression relevance to the user-specific or user-preferred genre for each video frame of the vocal segment, based on the vocal expression score (vsᵢ) for that vocal segment. The vocal expression relevance is utilized to determine the audio relevance.

In some embodiments, the audio analysis engine 136 can identify a background sound segment, identify sound effect features of the background sound, and determine a background relevance to a user-specific or user-preferred genre for the video frames included in the background sound segment based on the sound effect features of the background sound. For example, the audio analysis engine 136 can identify a musical segment presenting a piece of background music. The musical segment contains a subset of video frames, and the piece of background music spans the entirety of the video frames of the music segment. The audio analysis engine 136 can extract musical features from the musical background and determine a musical expression (e.g., emotion or mood) for the musical segment based on the musical features. Examples of the musical features include tempo (speed of the music), rhythm patterns, key (major or minor), harmony, melody, dynamics (variations in loudness), timbre (quality or color of the music), instrumentation, and lyrical content. The audio analysis engine 136 can determine a musical expression score (msᵢ) of the musical segment based on the musical features of the background music. The msᵢ is an indicator of the emotion or mood of the musical segment, and each video frame of the musical segment can have the same msᵢ. The msᵢ can be calculated based on a predefined formula specific to a predefined genre. For example, the calculated msᵢ for the “Romantic” genre and the calculated msᵢ for the “Horror” genre may be different for the same music segment. The audio analysis engine 136 can determine a musical expression relevance to the user-specific or user-preferred genre for each video frame of the musical segment, based on the musical expression score (msᵢ) for that musical segment. The musical expression relevance is utilized to determine the audio relevance.

In some embodiments, the audio analysis engine 136 can execute a function utilizing Equation (7) to calculate the musical expression score (msᵢ) for a video frame “i.”

$$m {s}_{i} = {\sum }_{class = i}^{class = n} m {\%}_{class} \times \{ \frac{\begin{matrix}1 \to if music is relevant \\ to a predefined genre\end{matrix}}{0 \to e l s e} \} ; \qquad Equation ( 7 )$$

In Equation (7), m %_{class} represents a musical index of a musical feature of a piece of an identified background music relevant to a class of standard musical features for a predefined genre. As an example, the predefined “Action” genre has a class of standard musical features or sound effects (e.g., sound of car chase, sound of gun shooting, sound of explosives, sound of fire, etc.). If a car chase is identified as a musical feature in the video frame “i,” the car chase is one of the class of standard musical features relevant to the “Action” genre, and the standard musical index for car chase is 10, the musical expression score (msᵢ₎ is calculated to be 10. If both sound of a gun shooting and sound of car chase are identified in the video frame, the sound of gun shooting and the sound of car chase are both of the class of standard musical features relevant to the “Action” genre, and the standard musical indices for the sound of gun shooting and the sound of car chase are 10 and 5 respectively, then the msᵢ is calculated to be 10×50%+5×50%=12.5. On the other hand, the sound of gun shooting and the sound of car chase are not a standard musical feature for the “Romantic” genre, and if sound of car chase is identified in the video frame “i,” the sound of car chase bears no weight in calculating the msᵢ for the “Romantic” genre, according to Equation (5), and the msᵢ is calculated to be 0 for the “Romantic” genre.

The text analysis engine 138 is operable and configured to identify textual features from the text metadata and determine a text expression based on the textural features. In some embodiments, the textual features can be identified from the subtitles, captions, or other textual information carried by the media content item. In some embodiments, the textual features are extracted from a vocal segment identified by the audio analysis engine 136, if no subtitle or textual information is available. For example, the text analysis engine 138 may convert the vocal expression presented in the vocal segment to text, and extract textual features from the converted text. Examples of the textual feature include Examples of textual features include sentiment, keywords and key phrases, named entity, topic, lexical diversity, syntactic patterns, contextual information, sentiment polarity and intensity, thematic, word frequency, co-occurrence patterns, among others. One or more textual expressions can be determined based on the textual features.

The text analysis engine 138 can further determine a text expression score (tsᵢ) based on the textual expression. The text expression score (tsᵢ) may be calculated based a predefined formula specific to a predefined genre. For example, if a predetermined relevant word or phrase indicative of a “Romantic” genre is identified in a dialogue or an occurrence of a predetermined relevant word or phrase is more frequent than a threshold, a higher tsᵢ can be obtained for the “Romantic” genre. The calculated tsᵢ for the same video frame may be different among the different predefined genres. In some embodiments, the tsᵢ is determined for a vocal segment identified by the audio analysis engine 136, and each one of the video frames in the vocal segment has the same tsⱼ. The text analysis engine 138 can further determine a text relevance to the user-specific or user-preferred genre based on the textual expression score (tsᵢ). The text relevance can be utilized as a factor to determine the video frame relevance for the video frame.

The video frame relevance determination engine 150 is operable and configured to determine a video frame relevance based on one or more of the image relevance, audio relevance, and text relevance. In some embodiments, the video frame relevance determination engine 150 can determine a final expression score (fesᵢ) for each video frame, based on one of more of the facial expression score (exᵢ), vocal expression score (vsᵢ), and text expression score (tsᵢ). In some embodiments, the video frame relevance determination engine 150 can execute a function by utilizing Equation (8) to determine the final expression score (fesᵢ).

$${fes}_{i} = \frac{{w}_{0} \times {ex}_{i} + {w}_{1} \times {ts}_{i} + {w}_{2} \times {vs}_{i}}{3} ; \qquad Equation ( 8 )$$

In Equation (8), the facial expression score (exᵢ), vocal expression score (vsᵢ), and text expression score (tsᵢ) are each assigned a weight, w₀, w₁, and w₂, respectively. The w₀, w₁, and w₂ can be calculated by Equation (9).

$${w}_{0 , 1 , 2} = \frac{\begin{matrix}Number of video frames \\ showing a relevant expression\end{matrix}}{Total number of video frames} ; \qquad Equation ( 9 )$$

The weight w₀, w₁, and w₂ may have different values depending on the relevance of the expression to the predefined genre. For example, for “Horror” genre, the w₃ may have a relatively larger value, indicating that the vocal expression score (vsᵢ) is assigned more weight in determining the fesᵢ. The values of w₀, w₁, and w₂ may vary depending on the scene or vocal segment. For example, in a scene or vocal segment presenting a horror expression or a horror sound effect (e.g., the character shown in the scene is not speaking but is screaming), the w₂ may have a larger value compared with w₀ and w₁. In some embodiments, the facial expression score (exᵢ), vocal expression score (vsᵢ), and text expression score (tsᵢ) are equally weighted (e.g., w₀=w₁=w₂₌₁).

The same video frame may have different values of fesᵢ for different predefined genres. When a user-specific or user-preferred genre is determined, the video frame relevance determination engine 150 can rank the video frames according to the fesᵢ, and select the video frame having the highest ranking of fesᵢ for generation of the targeted media clip.

In some embodiments, the video frame relevance determination engine 150 can determine a final video frame relevance score (fvrsᵢ) for a video frame (i) based on one or more of the prominence score (pᵢ), brightness score (bsᵢ), pose expression score (posᵢ), final expression score (fesᵢ), music expression score (msᵢ), and object score (obsᵢ). In some embodiments, the video frame relevance determination engine 150 can execute a function by utilizing Equation (10) to determine the fvrsᵢ.

$${fvrs}_{i} = \frac{\begin{matrix}{w}_{1} \times {ps}_{i} + {w}_{2} \times {bs}_{i} + {w}_{3} \times {pos}_{i} \\ {w}_{4} \times {fes}_{i +} {w}_{5} \times {ms}_{i +} {w}_{6} \times {obs}_{i}\end{matrix} +}{6} ; \qquad Equation ( 10 )$$

In Equation (10), the prominence score (pᵢ), brightness score (bsᵢ), pose expression score (posᵢ), final expression score (fesᵢ), music expression score (msᵢ), and object score (obsᵢ) are each assigned a weight w₁, w₂, w₃, w₄, w₅, and w₆, respectively. The weight w₁, w₂, w₃, w₄, w₅, and we are predetermined based on the predefined genre. For example, for “Comedy” genre, more weight can be assigned to fesᵢ and pᵢ. Accordingly, w₄ and w₁ can have relatively larger values for the “Comedy” genre. For “Horror” genre, more weight can be assigned to bsᵢ, msᵢ, fesᵢ, and psᵢ. Accordingly, w₁, w₂, w₄, and w₅ can have relatively larger values for the “Horror” genre. For “Action” genre, more weight can be assigned to msᵢ and obsᵢ. Accordingly, w₅ and w₆ can have relatively larger values for the “Action” genre.

In some embodiments, the prominence score (pᵢ), brightness score (bsᵢ), pose expression score (posᵢ), final expression score (fesᵢ), music expression score (msᵢ), and object score (obsᵢ) are equally weighted (e.g., w₁=w₂=w₃=w₄=w₅=w₆=1).

The same video frame may have different values of fvrsᵢ for different predefined genres. When a user-specific or user-preferred genre is determined, the video frame relevance determination engine 150 can rank the video frames according to the fvrsᵢ, and select the video frame having the highest ranking of fvrsᵢ for generation of the targeted media clip.

The media clip generation engine 160 is operable and configured to generate a media clip including the identified video frame having the highest ranking of the video frame relevance. In some embodiments, the media clip generation engine 160 can select the identified video frame as a thumbnail image for the targeted media clip. In some embodiments, the media clip generation engine 160 can select a group of video frames preceding the identified video frame and another group of video frames subsequent to the identified video frame to form the targeted media clip that continuously present a segment of content including the identified video frame. In some embodiments, the video frames of the media frame belong to the same scene (e.g., with the same scene ID).

In some embodiments, the media clip generation engine 160 can combine a group of consecutive video frames that have highest ranking to form the targeted media clip. In some embodiments, if multiple video frames from different scenes or scene segments (e.g., vocal segments, musical segments, etc.) are determined to have the highest ranking, the media clip generation engine 160 can further determine an average video frame relevance for the corresponding scene or scene segment each video frame belongs to and select the video frame having the highest average video frame relevance of the corresponding scene for generating the targeted media clip. In some embodiments, the media clip generation engine 160 can combine multiple scene segments to form the targeted media clip, each scene segment includes a video frame determined to have the highest ranking of video relevance within the corresponding scene. The total number of video frames of the targeted media clip (e.g., the duration of the targeted media clip) may vary depending on the user preference.

The media clip generation system 104 may provide access to the targeted media clip 172 to the user device 110. In some embodiments, an application 182 is executed on the user device 110 to receive a thumbnail image of the targeted media clip via a network (e.g., Internet) and display the thumbnail image in the user interface 184. In response to a user input selecting the thumbnail image, the application 182 can be executed to cause the user device to play the targeted media clip of the media content item and present to the user via the user interface 184. A selectable option for watching the full content of the media content item may be provided to the user in the user interface 184.

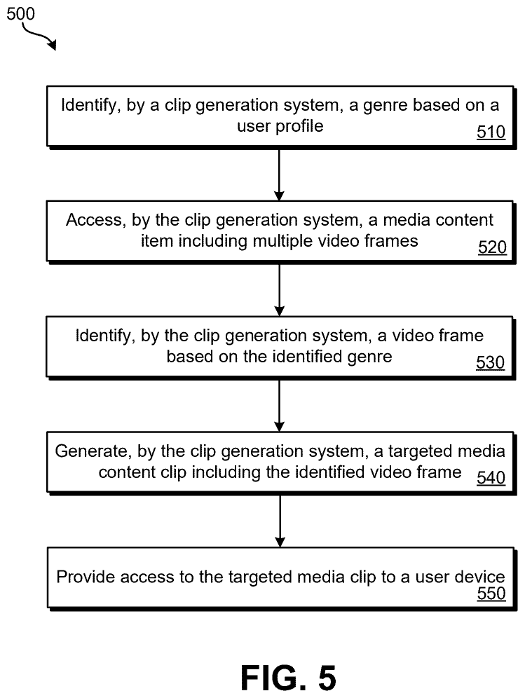

FIGS. 5-11 illustrate various examples methods for generating and providing targeted media clips by implementing the media clip generation system 104 and various components thereof. FIG. 5 illustrates an example method by implementing media clip generation system 104. Method 500 includes process blocks 510-550. At block 510, a user-specific genre is identified based on a user profile of a user or a user account by the media clip generation system 104. At block 520, a media content item containing a sequence of video frames and audio data corresponding to the video frames is accessed by the media clip generation system 104. At block 530, one or more video frames of the media content item relevant to the user-specific genre are identified by the media clip generation system 104. At block 540, a personalized media clip, targeted at the user or user account and containing the identified video frame(s), is generated by the media clip generation system 104. At block 550, access to the targeted media clip is provided to the user device 110 in response to a user request.

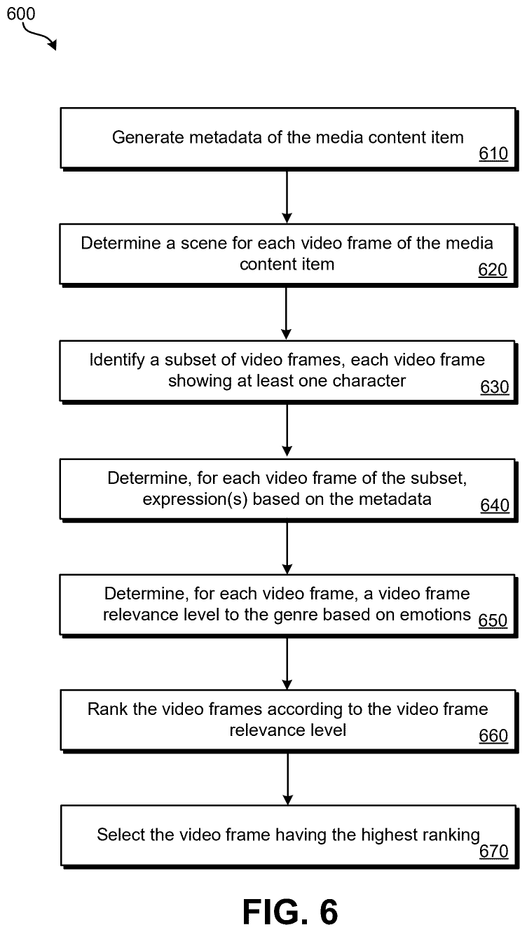

FIG. 6 illustrates an example method 600 by implementing the content analysis system 130. Method 600 includes process blocks 610-670. At block 610, video frame metadata of a media content item including a sequence of video frames is generated. The video frame metadata for each video frame may further include image metadata, audio metadata, and text metadata. At block 620, one or more scenes of the media content item are identified, and each video frame is assigned a scene of the one or more scenes. At block 630, a subset of video frames of the sequence of video frames are identified, and each video frame of the subset shows at least one character in the image of the video frame. At block 640, one or more expressions (e.g., emotions or moods) for each video frame of the subset are determined based on the video frame metadata. In some embodiments, the expression may be quantified as a relative level or degree or value. At block 650, a video frame relevance to the user-specific or user-preferred genre is determined based on the expressions. In some embodiments, the video frame relevance may be quantified as a relative level or degree or value. At block 660, the video frames of the subset are ranked according to the video frame relevance. At block 670, the video frame(s) having the highest ranking are identified as most relevant to the user-specific or user-preferred genre and selected to be included in the targeted media clip.

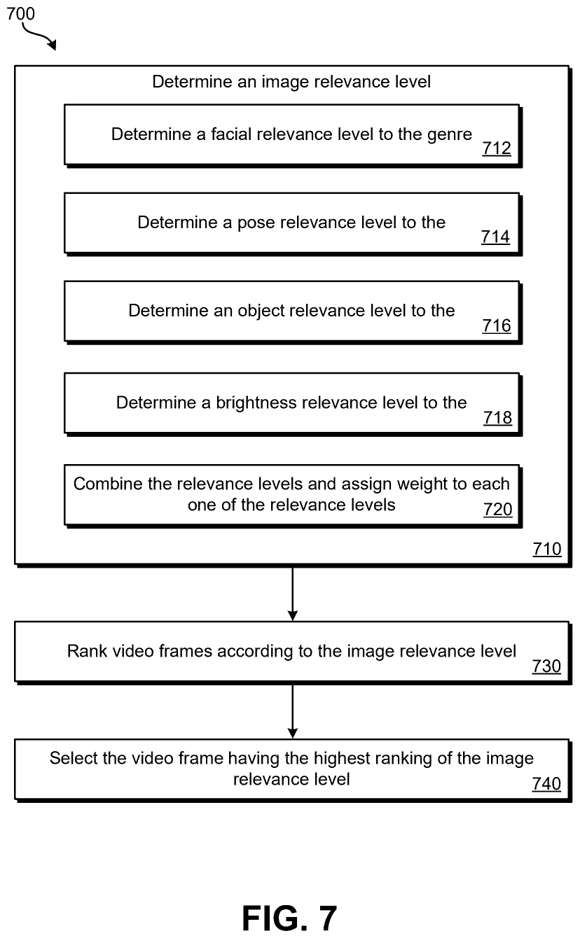

FIG. 7 illustrates an example method 700 for identifying a video frame relevant to a user-specific or user-preferred genre for generation of a targeted media clip of a media content item based on determination of image relevance. Method 700 can be performed by implementing the image analysis engine 140. In the illustrated example, method 700 includes process blocks 710, 730, and 740. At block 710, an image relevance to a user-specific or user-preferred genre is determined. Process block 710 may further include process blocks 712-720. At block 712, a facial expression relevance to the user-specific or user-preferred genre is determined, based on a combination of the prominence score (psᵢ) and facial expression score (exⱼ) determined by the facial analysis module 142. In some embodiments, the prominence score (psᵢ) and facial expression score (exⱼ) are weighted. At block 714, a pose relevance to the user-specific or user-preferred genre is determined, based on a pose expression score (posᵢ) determined by the pose analysis module 144. At block 716, an object relevance to the user-specific or user-preferred genre for each video frame of multiple video frames of a media content item is determined, based on an object score (obsᵢ) determined by the object analysis module 146. At block 718, a brightness relevance to the user-specific or user-preferred genre is determined, based on a brightness score (bsᵢ) determined by the brightness analysis module 148. At block 720, an image relevance is determined, based on one or more of the facial expression relevance, the pose expression relevance, the object relevance, and the brightness relevance. In some embodiments, two or more of the facial relevance, the pose relevance, the object relevance, and the brightness relevance are weighted and combined to yield the image relevance. In some embodiments, the image relevance is based on only one of the facial expression relevance, the pose expression relevance, the object relevance, and the brightness relevance. For example, the brightness relevance is the only factor of the image relevance. At block 730, the video frames are ranked according to the image relevance. At 740, the video frame having the highest ranking of the image relevance is selected and included in the targeted media clip.

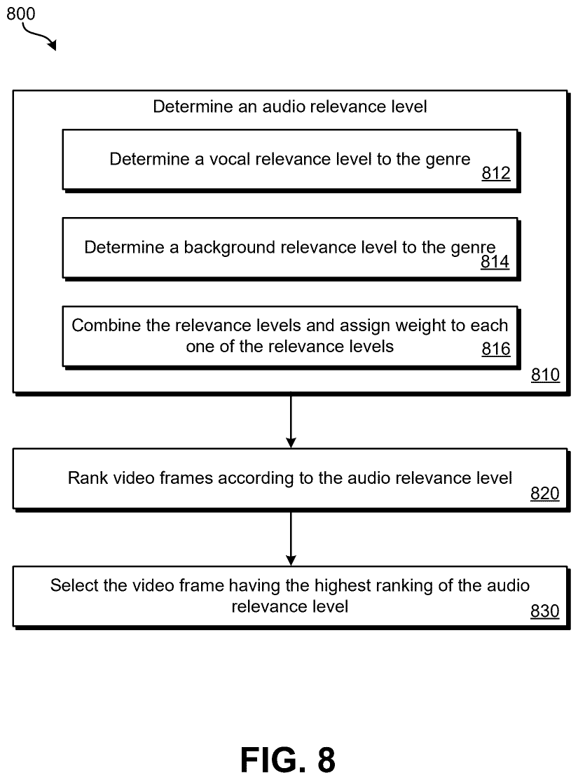

FIG. 8 illustrates an example method 800 for identifying a video frame relevant to a user-specific or user-preferred genre for generation of a targeted media clip of a media content item based on determination of audio relevance. Method 800 can be performed by implementing the audio analysis engine 136. In the illustrated example, method 800 includes process blocks 810-830. At block 810, a vocal relevance to a user-specific or user-preferred genre is determined for each video frame of multiple video frames of a media content item. Process block 810 may further include process blocks 812-816. At block 812, a vocal relevance to the user-specific or user-preferred genre is determined, based on a vocal expression score (vsᵢ). At block 814, a musical relevance to the user-specific or user-preferred genre is determined, based on a musical expression score (msᵢ). At block 816, the vsᵢ and msᵢ are weighted and combined to yield the audio relevance for each video frame. At 820, the video frames are ranked according to the audio relevance. At block 830, the video frame having the highest ranking of the audio relevance is selected and included in the targeted media clip.

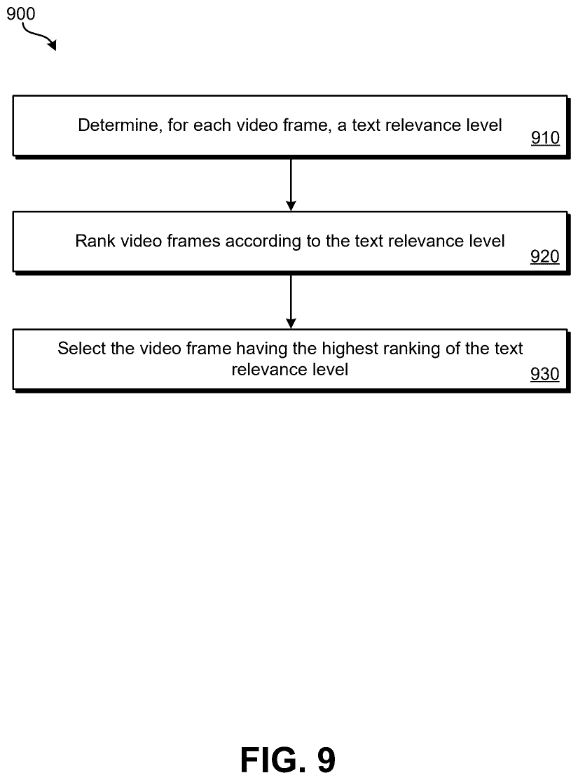

FIG. 9 illustrates an example method 900 for identifying a video frame relevant to a user-specific or user-preferred genre for generation of a targeted media clip of a media content item based on determination of text relevance. Method 900 can be performed by implementing the text analysis engine 138. In the illustrated example, method 900 includes process blocks 910-930. At block 910, a text relevance to a user-specific or user-preferred genre is determined. In some embodiments, a textual expression score (tsᵢ) is calculated, and the text relevance is determined based on the tsᵢ. At block 920, the video frames are ranked according to the text relevance. At block 930, the video frame having the highest ranking of the text relevance is selected and included in the targeted media clip.

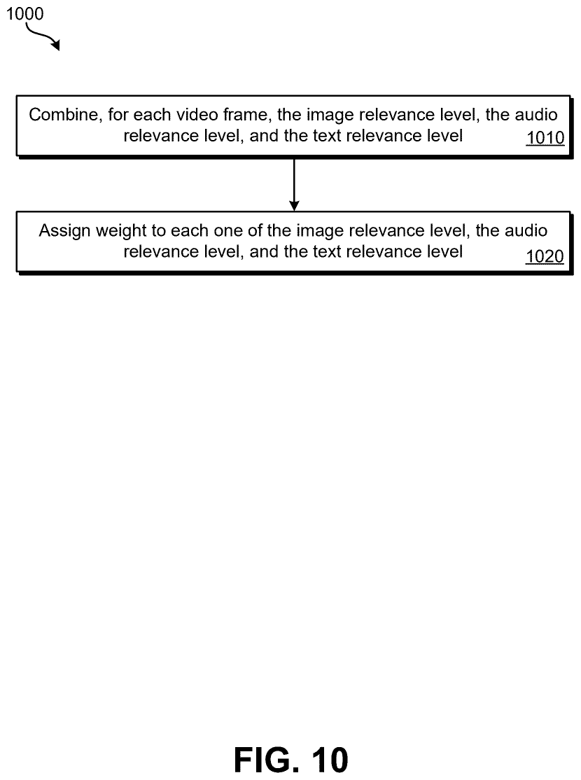

FIG. 10 illustrates an example method 1000 for identifying a video frame relevant to a user-specific or user-preferred genre for generation of a targeted media clip of a media content item based on determination of video frame relevance. Method 1000 can be performed by implementing the video frame relevance determination engine 150. In the illustrated example, method 1000 includes process blocks 1010-1020. At block 1010, a video frame relevance to a user-specific or user-preferred genre is determined for each video frame of multiple video frames of a media content item, based on a combination of image relevance, audio relevance, and text relevance. The multiple video frames each may show at least one character. Video frames that do not present a character are excluded. In some embodiments, a final video frame relevance score (fvrsᵢ) for a video frame (i) based on one or more of the prominence score (pᵢ), brightness score (bsᵢ), pose expression score (posᵢ), final expression score (fesᵢ), music expression score (msᵢ), and object score (obsᵢ). The video frame relevance is determined based on the fvrsᵢ. At block 1020, a weight is assigned to each the image relevance, audio relevance, and text relevance. In some embodiments, a weight is assigned to each one of the prominence score (pᵢ), brightness score (bsᵢ), pose expression score (posᵢ), final expression score (fesᵢ), music expression score (msᵢ), and object score (obsᵢ) to determine the final video frame relevance score (fvrsᵢ).

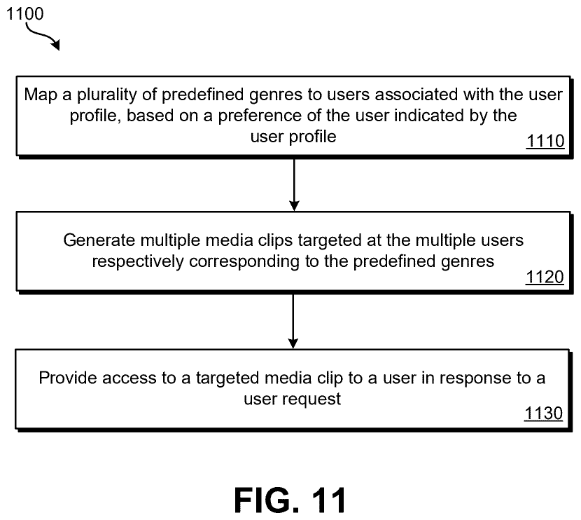

FIG. 11 illustrates an example method for generation of targeted media clips. Method 1100 includes process blocks 1110-1130. At block 1110, multiple predefined genres are mapped to multiple users, based user profiles indicating a user preference for each user. At block 1120, multiple targeted media clips of a media content item are generated. The multiple targeted media clips respectively correspond to the predefined genres (e.g., most relevant to the predefined genre). At block 1130, access to the media clip(s) is provided to a user in response to a user request. For example, if a predefined genre is determined to be the user-specific or user-preferred genre of a user, and the targeted media clip corresponding to the predefined genre is provided as a user-specific media clip to the user.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the disclosure.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the disclosure. Rather, the preceding description of the embodiments will provide those skilled in the art with an enabling description for implementing embodiments of the disclosure. Various changes may be made in the function and arrangement of elements without departing from the spirit and scope of the disclosure.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the disclosure. For example, the above elements may merely be a component of a larger system, wherein other rules may take precedence over or otherwise modify the application of the disclosure. Also, a number of steps may be undertaken before, during, or after the above elements are considered. Accordingly, the above description should not be taken as limiting the scope of the disclosure.

What is claimed is:

1. A method for generating targeted media clips, the method comprising:
identifying, by a media clip generation system, a genre based on a user profile;
accessing, by the media clip generation system, a media content item, wherein the media content item comprises a plurality of video frames;
identifying, by the media clip generation system, a video frame from the plurality of video frames based on the identified genre; and
generating, by the media clip generation system, a targeted media clip comprising the identified video frame.

2. The method of claim 1, wherein identifying the video frame further comprises:
identifying, for each one of the one or more video frames, a brightness;
determining a brightness relevance to the identified genre; and
ranking the one or more video frames according to the brightness relevance, wherein identifying the video frame from the plurality of video frames is further based on the ranking according to the brightness relevance.

3. The method of claim 1, wherein identifying the video frame further comprises:
identifying, for each one of the plurality of video frames, a facial expression of a character shown in the video frame;
determining a facial relevance to the identified genre; and
ranking the plurality video frames according to the facial relevance,
wherein identifying the video frame from the plurality of video frames is further based on the ranking according to the facial relevance.

4. The method of claim 1, wherein identifying the video frame further comprises:
identifying, for each one of the plurality of video frames, a pose expression of a character shown in the video frame;
determining a pose relevance to the identified genre; and
ranking the plurality of video frames according to the pose relevance,
wherein identifying the video frame from the plurality of video frames is further based on the ranking according to the pose relevance.

5. The method of claim 1, wherein identifying the video frame further comprises:
identifying, for each one of the plurality of video frames, one or more objects shown in the video frame;
determining an object relevance to the identified genre; and
ranking the plurality of video frames according to the object relevance,
wherein identifying the video frame from the plurality of video frames is further based on the ranking according to the object relevance.

6. The method of claim 1, wherein identifying the video frame further comprises:
determining, by the media clip generation system, an audio relevance for each one of the one or more video frames, based on audio data corresponding to the video frame.

7. The method of claim 6, wherein determining the audio relevance further comprises:
identifying a vocal expression of a character shown in the video frame, based on the audio data corresponding to the video frame; and
determining a vocal relevance to the identified genre based on the vocal expression.

8. The method of claim 7, wherein determining the audio relevance further comprises:
identifying a background expression of the video frame based on the audio data; and
determining a background relevance to the identified genre based on the vocal expression.

9. The method of claim 1, wherein identifying the video frame further comprises:
determining a text relevance to the identified genre based on at least one of:
a subtitle corresponding to the video frame; and
a text converted from a vocal expression of a character shown in the video frame.

10. The method of claim 1, further comprising:
identifying, by the media clip generation system, one or more video frames from the plurality of video frames, wherein each one of the one or more video frames shows at least one character; and
determining, for each one of the one or more video frames, a video frame relevance to the identified genre.

11. The method of claim 10, wherein determining the video frame relevance further comprises:
determining at least one of:
an image relevance to the identified genre;
an audio relevance to the identified genre; and
a text relevance to the identified genre;
wherein the video frame relevance is determined based on one or more of the image relevance, the audio relevance, and the text relevance.

12. The method of claim 11, further comprising:
assigning, by the media clip generation system, a weight to each one of the image relevance, the audio relevance, and the text relevance to determine the video frame relevance.

13. The method of claim 11, wherein determining the image relevance further comprises at least one of:
determining, for each one of the one or more video frames, a brightness relevance to the identified genre, based on a brightness of the video frame;
determining, for each one of the one or more video frames, a facial relevance to the identified genre, based on a facial expression of a character shown in the video frame;
determining, for each one of the one or more video frames, a pose relevance to the identified genre, based on a pose expression of a character shown in the video frame;
determining, for each one of the one or more video frames, an object relevance to the identified genre, based on one or more objects in the video frame; and
wherein the image relevance is determined by one or more of the brightness relevance, the facial relevance, the pose relevance, and the object relevance.

14. The method of claim 13, further comprising:
assigning, by the media clip generation system, a weight to each one of the brightness relevance, the facial relevance, the pose relevance, and the object relevance to determine the image relevance.

15. The method of claim 11, wherein determining the audio relevance further comprises at least one of:
determining, for each one of the one or more video frames, a vocal relevance to the identified genre, based on a vocal expression of the character identified from audio data corresponding to the video frame; and
determining, for each one of the one or more video frames, a background relevance to the identified genre, based on the audio data corresponding to the video frame,
wherein the image relevance is determined by one or both of the vocal relevance and the background relevance.

16. The method of claim 15, further comprising:
assigning, by the media clip generation system, a weight to each one of the vocal relevance and the background relevance to determine the audio relevance.

17. The method of claim 11, wherein determining the text relevance further comprises:
determining, for each one of the one or more video frames, a text relevance to the identified genre, based on at least one of:
a subtitle corresponding to the video frame; and
a text converted from a vocal express of the character.

18. The method of claim 1, further comprising:
identifying a plurality of scenes, wherein each scene of the plurality of scenes is associated with a subset of sequential video frames of the plurality of video frames;
determining the scene associated with the identified video frame; and
selecting one or more of the sequential video frames associated with the scene,
wherein the clip further comprises the selected video frames.

19. The method of claim 1, further comprising:
mapping a plurality of predefined genres to a plurality of users associated with the user profile, based on a preference of each one of the plurality of users indicated by the user profile;
generating a plurality of targeted media clips respectively corresponding to the plurality of the predefined genres; and
in response to a user request, providing access to the targeted media clip to the user according to the mapping.

20. A computer system comprising:
one or more processors; and
a computer-readable storage media storing computer-executable instructions, wherein the instructions, when executed by the one or more processors, cause the computer system to:
identify a genre based on a user profile;
access a media content item, wherein the media content item comprises a plurality of video frames;
identify a video frame from the plurality of video frames based on the identified genre; and
generate a targeted media clip comprising the identified video frame.
